(19) United States
(12) Patent Application Publication
(10) Pub. No.: US 2021/0101170 A1
(43) Pub. Date: Apr. 8, 2021

(54) SPRINKLER GUARD APPARATUS AND SYSTEM

(71) Applicant: Henry Vernon Reed, II, Hawthorne, CA (US)

(72) Inventor: Henry Vernon Reed, II, Hawthorne, CA (US)

(21) Appl. No.: 16/595,688

(22) Filed: Oct. 8, 2019

(51) Int. Cl. B05B 15/16

(52) U.S. Cl. CPC B05B 15/16

(57) ABSTRACT

Provided is a sprinkler guard apparatus that includes a top cover with a central opening. The apparatus further includes one or more retention spikes that extend below the top cover from a perimeter or edge of the top cover. The apparatus further includes a base mount with an edge protruding inward from the central opening at some height below the top cover. The top cover provides a rigid surface extending above the mount by a distance equal to or greater than a height of a head of a protected sprinkler. The rigid surface therefore rises above the sprinkler head to protect the sprinkler from impact. The apparatus further includes a shaft providing a protective housing extending around the central opening and below the base mount. The shaft surrounds a second opening with a diameter equal to or greater than a diameter of a body of a protected sprinkler.

### TECHNICAL FIELD

The invention relates to the field of irrigation, and specifically, sprinklers.

### BACKGROUND INFORMATION

Sprinklers may include pop-up or fixed units that are installed in-ground or above-ground. Each unit may connect to a waterline or pipe, and may distribute water in certain patterns or directions from a sprinkler head. For a pop-up sprinkler, the sprinkler head may be an extension that rises vertically from the sprinkler body in response to water pressure.

Sprinklers, in general, are fragile. Some are manufactured purely out of plastic, others may have metal components. In any case, sprinklers are small in size, connected to fragile piping (usually made of plastic), and can break or suffer damage when passed over by a lawn mower, foot traffic, vehicles, and/or other objects and subjected to vertical impact. Moreover, the sprinklers can be horizontally displaced when impacted from a side, and the horizontal displacement may also break or damage the sprinkler or the connected waterline or pipe, leading to difficult underground repairs.

### BRIEF DESCRIPTION OF THE DRAWINGS

FIG. 1 provides a top view of the sprinkler guard disk system (“SGDS”) in accordance with some embodiments presented herein.

FIG. 2 provides a top perspective view of the SGDS in accordance with some embodiments presented herein.

FIG. 3 provides a partially cutaway side view of the SGDS in accordance with some embodiments presented herein.

FIG. 4 provides a side perspective view of the SGDS in accordance with some embodiments presented herein.

### DETAILED DESCRIPTION OF PREFERRED EMBODIMENTS

The following detailed description refers to the accompanying drawings. The same reference numbers in different drawings may identify the same or similar elements.

Disclosed is a sprinkler guard disk system (“SGDS”). The SGDS provides a protective housing to shield a variety of different sprinklers (e.g., different types, sizes, shapes, etc.) from breakage or damage by providing external durability as well as vertical and horizontal stability. In other words, the SGDS may protect a sprinkler from vertical and horizontal impacts of foot traffic, lawn mowers, vehicles, and/or other forces, thereby reducing or eliminating the possibility of the sprinkler or connected piping from damage or breakage. The SGDS further provides simple deployment and installation.

The SGDS has residential and commercial applications. For instance, the SGDS may be used to protect residential sprinklers such as the Rain Bird® series 1800 sprinklers and/or other sprinkler designs, configurations, shapes, dimensions, etc. The SGDS may also be used in golf courses, parks, and/or other public or commercial environments that rely on different sprinkler systems and sprinklers. For each such application or different support sprinkler, the base components and structure of the SGDS remains the same, although the SGDS may include a different adapter or receptacle to accommodate the size or shape of each supported sprinkler.

The SGDS includes a load-bearing protective housing that discreetly shields a sprinkler from all sides (e.g., top, sides, and below or underground). The SGDS simplifies deployment by using a single stage drop-in design, whereby a user simply inserts a sprinkler into the SGDS before installing the combined protected unit in the same manner as installing an unprotected sprinkler on a waterline or pipe. Accordingly, the SGDS may be added to existing sprinklers without modification of the sprinklers.

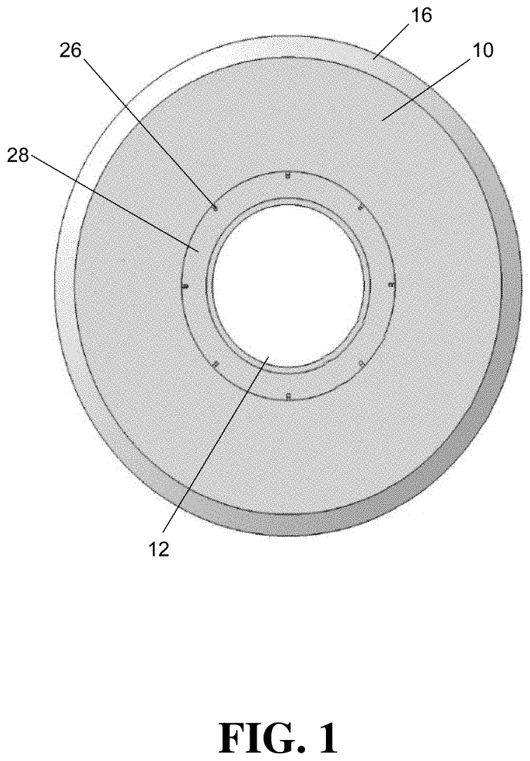

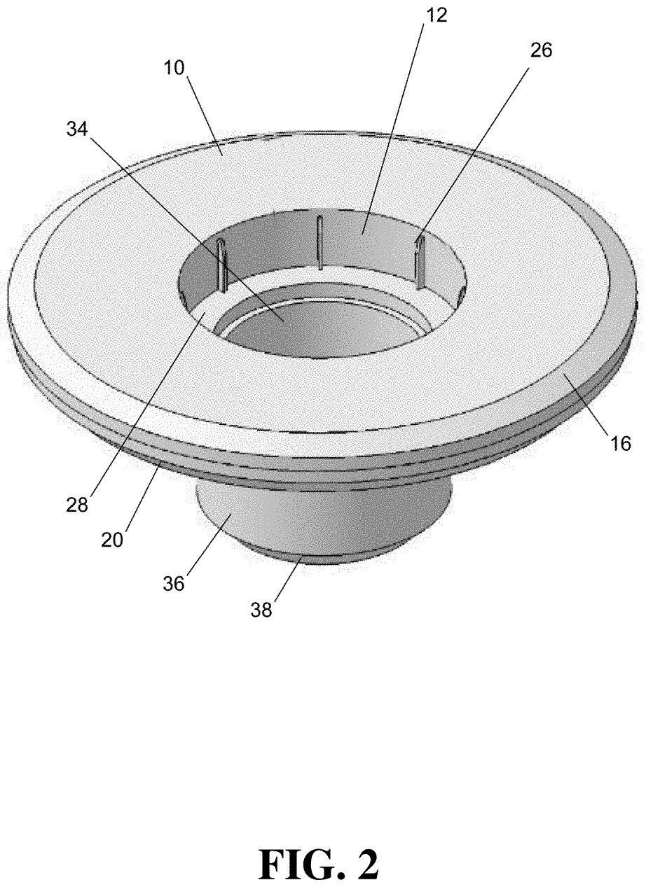

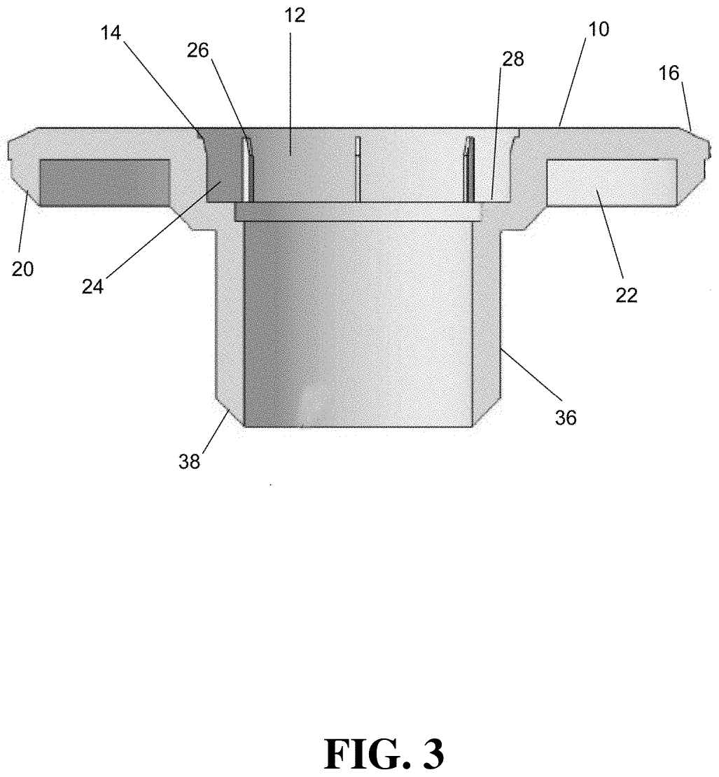

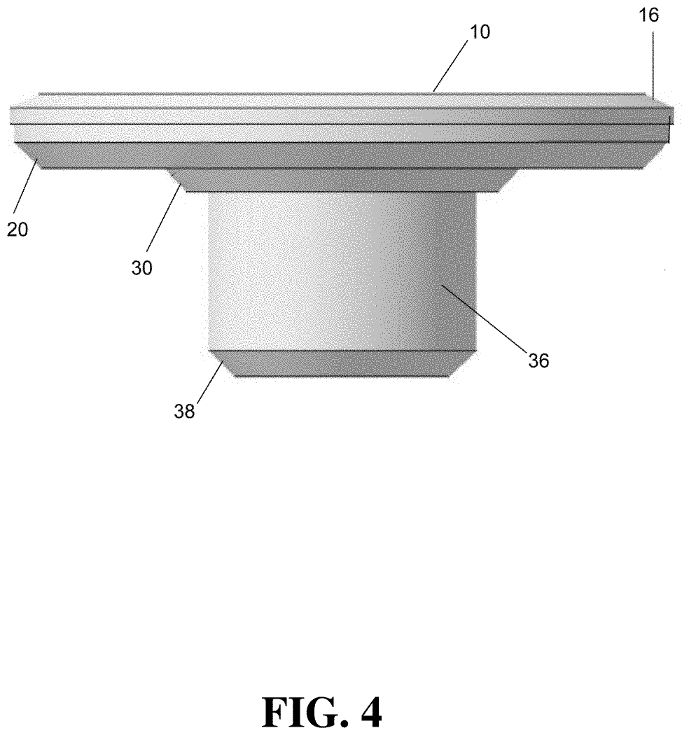

FIG. 1 provides a top view of SGDS 5, FIG. 2 provides a top perspective view of SGDS 5, FIG. 3 provides a partially cutaway side view of SGDS 5, and FIG. 4 provides a side perspective view of SGDS 5 in accordance with some embodiments presented herein. As shown in the top view of FIG. 1, SGDS 5 includes top plate cover body 10 with angled rim 16, and central opening 12 with internal base mount 28 and mounting edges 26. These and other structures of SGDS 5 may be seen in FIGS. 2-4.

Top plate cover body 10 includes a raised protective surface that is positioned over a height of a sprinkler protected by SGDS 5 (e.g., a sprinkler that is inserted into opening 12 and retained in place by internal base mount 28). For instance, top plate cover body 10 may rise one inch or several millimeters above a ground surface and a top of a sprinkler head when SGDS 5 is coupled with a sprinkler.

Top plate cover body 10 may include a rigid material that can withstand vertically imposed forces of a lawn mower, foot traffic, a vehicle, and/or other objects. For instance, top plate cover body 10 may be made of a rigid plastic, metal, or other rigid material that does not or only minimally distorts in response to applied vertical force.

Top plate cover body 10 may be circular in shape to conform with a circular shape of a protected sprinkler. Top plate cover body 10 may have other regular or irregular shapes.

In some embodiments, top plate cover body 10 may be flat or parallel to the surface on which SGDS 5 is installed. In some other embodiments, top plate cover body 10 may have a sloped surface that slopes downward from a center (e.g., opening 12) to a perimeter of top plate cover body 10.

The perimeter or outer edge of top plate cover body 10 may include angled rim 16. As can be seen in FIG. 2, angled rim 16 may extend downwards at an angle from an outer circumference or edge of top plate cover body 10.

Angled rim 16 may direct water away from top plate cover body 10 to an area (e.g., land) around SGDS 5. The bottommost portion of angled rim 16 may come into contact with the ground surface when SGDS 5 is installed in conjunction with a sprinkler, or may be elevated off the ground surface by a few millimeters.

Central opening 12 is a cavity about the center of SGDS 5. The size (e.g., diameter) of central opening 12 may be about equal to the size (e.g., diameter) of the head of a sprinkler that is protected by that SGDS 5. The protected sprinkler is inserted into central opening 12.

FIG. 2 illustrates the interior of central opening 12 in order to better illustrate internal base mount 28 and mounting edges 26 that are used to align and/or retain the position of the sprinkler within SGDS 5. Internal base mount 28 may be an edge or surface that protrudes out some distance from central opening 12 towards a center of SGDS 5. Internal base mount 28 is positioned below top plate cover body 10 at a distance that is greater than or equal to a height of a sprinkler head. Similarly, the distance that internal base mount 28 extends outwards from central opening 12 towards a center of SGDS 5 may be equal to or less than the distance separating the far edge or perimeter of the sprinkler head from the far edge or perimeter of the sprinkler body.

When a sprinkler is placed into central opening 12, the sprinkler body will pass through central opening 12 and past internal base mount 28. However, the larger sprinkler head may only pass through top plate cover body 10 until it is below top plate cover body 10 before internal base mount 28 contacts the sprinkler head and stops the sprinkler from passing further down into SGDS 5. In other words, the recessed or protruding edge of internal base mount 28 may abut the sprinkler head from below when the sprinkler is inserted within central opening 12, and may stop the sprinkler head or top portion of the sprinkler from sliding past internal base mount 28.

In some embodiments, different units of SGDS 5 may change the size and placement (e.g., height and width) of internal base mount 28 to correspond to different heights, sizes, and/or shapes of different sprinkler heads. For example, the sprinkler may include a head that rises one inch from the narrower sprinkler body. In this example, the internal base mount 28 may be positioned more than one inch down from a top of central opening 12 so that the sprinkler top lies slightly below the height of top plate cover body 10, and is protected from vertical impact by top plate cover body 10.

Mounting edges 26 may include one or more vertical protrusions that extend outward from central opening 12 with a depth that is less than the depth of internal base mount 28. Mounting edges 26 may be notches that are aligned with and fit into vertical grooves about a sprinkler head. When mounting edges 26 are aligned and placed within the vertical grooves of a sprinkler head, mounting edges 26 may further retain a position of the sprinkler within SGDS 5, and prevent the sprinkler from twisting, rotating, or otherwise displacing within SGDS 5.

The partially cutaway side view of FIG. 3 illustrates additional structures of SGDS 5. In particular, SGDS 5 may include retention spikes 20, side openings 22, and shaft 36.

In some embodiments, retention spikes 20 may include a continuous lip that extends downwards or underneath the outermost edge or perimeter of top plate cover body 10. In some other embodiments, retention spikes 20 may include one or more non-continuous extensions that extend downwards or underneath the outermost edge or perimeter of top plate cover body 10.

Side openings 22 separate retention spikes 20 from shaft 36, and provide a void or gap between the downward extension of retention spikes 20 and the rest of SGDS 5. The height of the gap may correspond to a height of retention spikes 20, and the width of gap may be one or more inches.

Retention spikes 20 are used to anchor SGDS 5 into place (e.g., into the ground), and to prevent movement of SGDS 5 once installed. Retention spikes 20 also help to retain the position of SGDS 5 when impacted by a vertical or horizontal force. For instance, a compatible sprinkler may be inset within SGDS 5. An installer may then place SGDS 5 with the integrated sprinkler onto a threaded waterline or pipe that is in a hole in the ground. The installer may then turn SGDS 5 to screw the sprinkler onto the threaded waterline or pipe. Each turn brings SGDS 5 closer to the ground until the retention spikes 20 dig into the ground with the sprinkler being tightly coupled to the threaded waterline or pipe. If a vertical or horizontal force is placed against top plate cover body 10 or SGDS 5, retention spikes 20 will prevent or minimize displacement.

Shaft 36 is a protective covering that extends below the height of retention spikes 20. Shaft 36 may be made of a rigid material (e.g., a similar material as top plate cover body 10).

Shaft 36 surrounds the lower part of the sprinkler that is protected by SGDS 5, and specifically the sprinkler body that extends below the sprinkler head. Shaft 36 provides durability and stability to the lower part of SGDS 5 as well as the lower part of the protected sprinkler. In particular, shaft 36 retains the upward position of SGDS 5 and the protected sprinkler even when subjected to varying vertical and/or horizontal forces. For instance, vibrations from an operating unprotected sprinkler may displace the surrounding dirt over time causing the sprinkler to move from its original installed position. Even a small shift in the sprinkler's position can affect the distribution of water from the sprinkler leading to uneven or undesired watering. Shaft 36 prevents the movement or shifting of the sprinkler by creating a channel that does not distort or deform over time as a result of vibrations of the sprinkler.

In some embodiments, the bottom of shaft 36 may include angled tip 38. Angled tip 38 may narrow the bottom of shaft 36 to aid in SGDS 5 placement. For instance, angled tip 38 may assist in digging SGDS 5 into the ground and displacing dirt when the hole into which SGDS 5 is to be inserted is smaller than the diameter of shaft 36.

FIG. 4 illustrates angled tip 38 and the entire outer structure of SGDS 5 from a side view. FIGS. 1-4 illustrate a preferred embodiment of SGDS 5. The dimensions of SGDS 5 may change to integrate with and protect different sprinklers (e.g., sprinklers from different manufacturers, sprinklers of different dimensions, or different types of sprinklers). For instance, the diameter of central opening 12 and width of internal base mount 28 may be increased or decreased to match the diameter of different sprinklers. As a specific example, the diameter of a first sprinkler from a first manufacturer may be two inches, and the diameter of a second sprinkler from a second manufacturer may be three inches. Accordingly, some embodiments may provide a first SGDS 5 with central opening 12 that is two inches in diameter, and a second SGDS 5 with central opening 12 that is three inches in diameter. Similarly, the placement and size of mounting edges 26 may be adapted to accommodate the grooves about the perimeter of different sprinklers.

The foregoing description of implementations provides illustration and description, but is not intended to be exhaustive or to limit the possible implementations to the precise form disclosed. Modifications and variations are possible in light of the above disclosure or may be acquired from practice of the implementations.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

We claim:

1. A sprinkler guard apparatus comprising:
a top cover with a central opening;
one or more retention spikes that extend below the top cover from a perimeter or edge of the top cover;
a base mount comprising an edge protruding inward from the central opening at some height below a top of the central opening, wherein the edge extends inward a distance that is less than a size of the central opening; and
a shaft comprising a protective housing extending around the central opening and below the base mount.

2. The apparatus of claim 1, wherein the height separating the base mount from the top of the central opening is equal to or greater than a height of a head of a sprinkler that is inset in the apparatus.

3. The apparatus of claim 1, wherein a size of the central opening is equal to or greater than a size of a sprinkler head adapted to fit in the apparatus.

4. The apparatus of claim 3, wherein the edge of the base mount protrudes inward a distance that is equal to or less than a distance that the sprinkler head is separated from a sprinkler body.

5. The apparatus of claim 1, wherein the top cover comprises a rigid protective shell that extends over and around the central opening.

6. The apparatus of claim 1 further comprises a plurality of vertical notches distributed across a wall of the central opening, each notch of the plurality of vertical notches protruding inward by a distance less than the edge of the base mount, and each notch extending above the base mount.

7. The apparatus of claim 1, wherein the top cover slopes downward from the central opening towards the perimeter or the edge.

8. An apparatus for protecting a sprinkler, the apparatus comprising:
a shaft comprising a downward extending protective housing surrounding a first opening with a diameter equal to or greater than a diameter of a body of the sprinkler;
a mount comprising a solid surface that extends outward over the first opening of the shaft with a width equal to or greater than a distance separating the body of the sprinkler from a larger head of the sprinkler; and
a top cover comprising a rigid surface and a second opening, the rigid surface extending above the mount by a distance equal to or greater than a height of the head of the sprinkler, the second opening having a diameter equal to or greater than a diameter of the head of the sprinkler.

9. The apparatus of claim 8, wherein the rigid surface of the top cover further extends outward at a downward angle from the second opening.

10. The apparatus of claim 8, wherein the rigid surface of the top cover further extends outward and parallel to a top of the second opening.

11. The apparatus of claim 8, wherein the top cover further comprises one or more retention spikes that extend downward from underneath the top cover, the one or more retention spikes providing anchors for digging into a ground surface and retaining a position of the apparatus relative to the ground surface.

12. The apparatus of claim 8, wherein the top cover is a disc made of a rigid plastic or metal.

13. The apparatus of claim 8, wherein the perimeter of the rigid surface of the top cover comprises an angled rim that extends downwards at an angle greater than an angle at which the rigid surface extends outward from the second opening.

14. The apparatus of claim 8, wherein a length of the shaft is equal to or less than a length of the body of the sprinkler.

15. The apparatus of claim 8 further comprising a plurality of vertical notches that extend upward and around the mount, wherein the plurality of vertical notches are aligned with a plurality of vertical grooves about the head of the sprinkler.
